(19) United States
(12) Patent Application Publication
(10) Pub. No.: US 2009/0170974 A1
(43) Pub. Date: Jul. 2, 2009

(54) REACTIVE DILUENT FOR ONE OR TWO COMPONENT PU FOAMS

(76) Inventors: Aster De Schrijver, Deurle (BE); Joao Carlos Moura Bordado, Lisboa (PT)

Correspondence Address: YOUNG & THOMPSON, 209 Madison Street, Suite 500, ALEXANDRIA, VA, 22314, US

(21) Appl. No.: 12/097,561

(22) PCT Filed: Dec. 14, 2006
(86) PCT No.: PCT/EP2006/012055

§ 371 Date: Sep. 29, 2008

(30) Foreign Application Priority Data
Dec. 14, 2005 (EP) 05077859.6

(51) Int. Cl. C08G 18/00

(52) U.S. Cl. 521/157; 521/155; 521/159

(57) ABSTRACT

The invention is directed to a polymer foam precursor composition comprising 1 to 60%, preferably 5 to 30% by weight, of a biodiesel obtained by transesterification of vegetable oils. The polymer foam is advantageously a polyurethane foam and the biodiesel is a mixture of methyl and or ethyl fatty acid esters. The biodiesel is a latent hardener and/or extender and/or liquid filler The composition is advantageously used in pressurized vessel or aerosol type cans.

One component Polyurethane Foams (OCF) are well known and used in aerosol type cans for numerous purposes.

Several diluents and extenders have been used in the past in the production of one-component Polyurethane Foam (OCF).

The more commonly used compounds are chlorinated paraffin and tris-dicloropropylphosphate. When flame retardancy is not a requirement conventional plasticizers such as DOP, DBP, DIOP and DIDP can also be used to a certain extent but with drawbacks since their use induces outflow and variation in long term performance due to slow migration from the foam to the atmosphere.

These long-term changes are mainly
lower dimensional stability with occasional cracking,
loss of adhesion to the substrates,
friability and lower resistance to abrasion.

There is therefore still a need for improved shelf life and more constant long-term dimensional stability, as well as improved sealing effect.

The purpose of the present invention is to provide such an improved composition which will also avoid long-term deterioration of flexibility and mechanical strength of the foam. Another advantage is the reduced cost of production.

According to the invention precursors to polyurethane foams, more particularly One component Polyurethane Foams with improved long-term performance were developed by using “Biodiesel” as extender and latent hardener.

### BACKGROUND OF THE INVENTION

According to one aspect, the present invention is concerned with a new composition and a production method to manufacture precursor mixtures in Aerosol type cans for the so-called one component Polyurethane Foam (O.C.F.)

These precursor mixtures are mainly prepared from 4,4′ diphenyl methane di-isocyanate (MDI) and polyether polyols which by chemical reaction lead to a liquid quasi-prepolymer with isocyante functionality.

Several additives have to be used to improve specific properties of the final foam, such as flame-retardants, plasticizers, extenders and catalysts.

The isocyanate quasi-prepolymers used in the process according to the present invention may be selected from those disclosed in EP 392788, but many other macromolecular structures of MDI based quasi-prepolymers can also be used.

Preferred isocyanate quasi-prepolymers are made from polyether-polyols and calculated stoechiometric excess of diphenylmethane di-isocyanate composition.

Preferred polyols have an average functionality between 2 and 3 and a number average molecular weight of 500 to 6000 and mostly in the range 1000 to 4800.

The isocyanate terminated quasi-prepolymer compositions may further be blended in the can with other additives and compositions but the free NCO content should remain between 2 and 18% and preferably between 8 and 15% to assure the required reactivity of the liquid froth towards the atmospheric moisture.

Reaction temperature in the can during the mixture and after gas filling should remain in the range 5° C. to 60° C. and preferably between 20° C. and 45° C. to avoid segregation at low temperature, and side reactions at high temperature such as allophanate formation, both leading to reduction of shelf life of the can mixture.

### Main Components of the OCF Foam

The OCF precursor mixture included in the Aerosol type can with a special valve, is generally produced from the following main components:
Polyol or Polyol mixture
Di or poly-isocyanate
Surface active agent
Catalyst
Flame retardant
Extender and/or plasticizer
Colorant (optional)
Compatibilizing Gas
Pressurizing gas mixture

### Polyol or Mixture of Polyols

The polyols which can be utilized in the present invention include, but are not limited to, the following polyether polyols:
(a) alkylene oxide adducts of polyhydroxyalkanes;
(b) alkylene oxide adducts of non-reducing sugars and sugar derivations;
(c) alkylene oxide adducts of polyphenols; and
(d) alkyleneoxide adducts of polyamines and polyhydroxyamines. Alkylene oxides having two to four carbon atoms generally are employed, with propylene oxide, ethylene oxide and mixtures therefore being particularly preferred.

Any material having active hydrogens as determinated by the Zerewitinoff method, may be utilized to some extent and therefore is included within the broad definition of the polyols. For example, amine-terminated polyether polyols, hydroxyl-terminated polybutadiene polyols and many others are known and may be used as a minor component in combination with the above identified conventional polyether polyols.

Generally, the polyol compound should have an equivalent weight in the range of about 400 to about 6000 grams/equivalent and an ethylene oxide content of less than 20%. Preferably the equivalent weight is in the range of about 500 to about 2000 grams/equivalent, and most preferably between about 1000 and 4800 grams/equivalent. The polyol or polyol blend should have an average hydroxyl functionality of at least 2. The equivalent weight is determined from the measured hydroxyl number. The hydroxyl number is defined as the number of milligrams of potassium hydroxide required for the complete hydrolysis of the fully acetylated derivative prepared from one gram of polyol. The relationship between the hydroxyl number and equivalent weight is defined by the equation:

OH=56,100/equivalent weight where OH equals the hydroxyl number of the polyol.

Preferably the polyols should include
poly(oxypropylene) and
poly(oxyethyleneoxypropylene) triols.

Ethylene oxide, when used, can be incorporated in any fashion along the polymer chain. Stated another way, the ethylene oxide can be incorporated either in internal blocks, as terminal blocks, or may be randomly distributed along the polyol chain.

However, the manner of incorporation and the ethylene oxide content of the polyol preferably is as noted above. Thus, ethylene oxide is used at a level below about 20% by weight preferably below about 15% by weight, and is located primarily within the interior of the polyol chain.

The amount of polyol used is determinated by the amount of product to be produced. Such amounts may be readily by one skilled in the art.

### Di-Isocyanates or Polyisocyanates

Organic isocyanates useful in producing polyurethane foam in accordance with this invention are organic compounds that contain, on average, between about one and a half to about six isocyanate groups and preferably about two isocyanate groups.

Suitable organic polyisocyanates include the hydrocarbon diisocyanates, e.g., the alkylene diisocyanates are the aryldiisocyanates and more specifically, diphenylmethane diisocyanate.

The amount of isocyanate to be used is dependent upon the index of foam desired and the final properties of the foam to be formed. If the index is 100 then there is a stoichiometric equivalent of the amount of isocyanate needed to react with the polyol component and the other active hydrogen containing components in the system. While the present invention may be practiced in a wide range of indexes, the preferred range of use is indexes between 150 to 500 (hereinafter “High Index”). Foams with indexes above 500 (very high index foams) often show no increased hardening due to the stoichiometricexcess of isocyanates when used in conventional range of atmospheric moisture.

Within the range of indexes of 150 to 500 it is known in the art that small wings in the index may lead to dramatic changes in foam stability

### Foaming Agents

Water is in this case a secondary blowing agent to produce carbon dioxide by reaction with isocyanate while curing. Other blowing agents that are conventionally used in the art may be used here in, but because of the utility of the formulation of the present invention, large amounts of such agents are no longer needed. Main Foaming agents include propane, butane, isobutene, dimethylether and their mixtures in all proportions.

### Surface Active Agents

Suitable stabilizers include “hydrolysable” polysiloxane-polyoxyalkylene block copolymers. Another useful class of loam stabilizers are the “non-hydrolysable” polysiloxane-polyoxyalkylene block copolymers. The latter class of copolymers differs from the above-mentioned polysiloxane-polyoxyalkylene block copolymers in that the polysiloxane moiety is bonded to the polyoxyalkylene moiety through direct carbon-to-silicon bonds, rather than through carbon-to-oxygen-to-silicon bonds.

The stabilizer should be present at about 0.0001 percent to about 5 percent by weight of the total reaction mixture and preferably between 0,01 and 2 percent by weight.

### Catalysts

Catalyst to be used include the standard combinations of tertiary amine and organometallic polyurethane catalysts which should be present at about 0.0001 to 5 weight percent of the reaction mixture. Suitable catalysts include, but are not limited to, dialkyltin salts of carboxylic acid, salts of organic acids, triethylene diamine (TEDA), bis (2,2 1-dimethylamioethyl) either and similar compounds that are known to the art. Catalysts that do not promote allophanate formation are preferred to avoid viscosity drifting on storage.

### Foam Processing Art

A foam processing aid sometimes called Foam Control Agent is used for enhancing the properties of low density, foam processing aid includes a cross linking agent and/or extending agent and preferably a sufficient amount of stabilizer agent, to yield a polyurethane loam having a specific gravity between 10 and 50 kg/m3.

### DETAILED DESCRIPTION OF THE INVENTION

Bio diesel was tested as extender in an OCF formulation, with rather surprising effects which may be summarised as:

### Improved Shelf Life

In the absence of oxygen the remaining double bonds of Bio diesel do not react and diluting the [NCO] concentration prevent to a certain extent the allophanate formation that leads to higher viscosities.

### Higher Long-Terml Stability of the Foam

Bio diesel molecules, mainly C16 and C18 aliphatic methyl esters with some double bonds on the backbone tend to act as semi-drying oils forming some cross-links by reaction induced by the atmospheric oxygen. It is speculated that this reaction although very slow (2 to 6 months) prevents the migration of the Bio diesel, improving the long-term stability.

### Lower Viscosity and High Debit

The rather low viscosity of the Bio diesel lowers the viscosity of the mixture in the aerosol can or pressure vessel assuring an high debit (and shaking characteristics. However, excess of Bio diesel in the formulation can result in out flow of the froth.

In two component systems, in particular 2KPU rigid foam systems, similar advantages were observed.

The preferred biodiesels to be used according to the invention for the preparation of polyurethane foam precursors are produced by transesterification of vegetable oils in the presence of methanol and/or ethanol.

The preferred biodiesel is Biodiesel 100% (B100) also called “only Biodiesel” and is produced by the transesterification with methanol of vegetable oils, mostly rapeseed (colza), sunflower, high oleic sunflower and soybean oils. Biodiesel is a renewable non-toxic raw material. It consists mainly of a mixture of fatty acid methyl esters, some of them being unsaturated. For example, soybean methyl ester contains palmitic (12%) and stearic (5%) methyl ester together with oleic (25%), linoleic (52%) and linoleic (6%) methyl esters which are ethylenically unsaturated fatty esters.

Biodiesel 100% is also called FAME (Fatty Acids Methyl Esters), is being increasingly available and cheaper, as it can be mixed in the (petro)diesel fuel in several different proportions. More common mixtures include 5% or 30% of FAME.

Semi-refined degummed oils are used and the degumming or winterisation step removes a wax fraction that contains triglyceride fraction with the higher saturated long chain fatty content.

Biodiesel is therefore slightly unsaturated and this characteristic is measured by the iodine value that will depend mostly on the type of oil used for the production.

Biodiesel can also be produced using ethanol instead of methanol, leading to the mixture of Ethylesters of the fatty acids.

Viscosity of this type of Bio diesel is slightly higher and economic feasibility occurs only where excess of Bio ethanol is present in the market.

Biodiesel quality parameters impose a very low residual content of glycerine (below 0.2%) and also a very low alkaline metal (Na+K+Li) content: below 5 p.p.m.

Residual free methanol content varies from producer to producer but is always very low (below 0.1%).

Analytical determination of hydroxyl value was performed on more than 20 samples with different origins and measured hydroxyl value was always below 1 mg of KOH per gram and very often below 0.5 mg of KOH per gram.

This very low hydroxyl value is of importance in the production of the precursor of the foam since it leads to a very low consumption of additional amount of the di-isocyanate.

This very low hydroxyl value is also important because it reduces the content of urethane linkages in the mixture contributing therefore for the stability (shelf life) by prevention of an allophanate formation.

The very low content of residual glycerine is of utmost importance since it avoids the formation of oligomers with functionality 3 and higher that would lead to high viscosity and reduced shelf life.

The process of the invention provides also an biodiesel additive which is very compatible with the pressurizing gases and since it contains a methyl ester group with some polarity the content of compatibilizers such as DME can be reduced and in some cases eliminated.

It should be noted that the biodiesel according to the invention may also be used in two component PU formulations, contained in the polyol side, as shown below in an example of formulation.

The use of biodiesel as diluent and late hardener for the preparation of precursor compositions may also be applied for the preparation of other polymeric material such as polyester.

### GLOSSARY

### Prepolymer (Isocyanate Prepolymer)

Oligomeric reactive structure with isocyanate functionality

### Quasi-Prepolymer

Mixture containing prepolymer molecules and non-reacted di or poly-isocyanate

### Extender

Non-reacting additive with incidence on the mechanical properties of the final foam (flexibility, reduction of friability)

### Compatibilizing Gas

Pressuring gas with heteroatoms and polarity, typically dimethylether (DME) that assures compatibility of the liquid mixture with hydrocarbon gases.

### Examples of Suitable Formulations

1-OCF (1 KPU) gun foam in aerosol can

| | | | |
|---|---|---|---|
| Polyol | 156 | g | triol OP/glycerol MW 1000 |
| | | | OHv 160; Voranol ™ 1050 |
| Chain extender | 2 | g | propanediol; Altachem ™ FCA100 |
| Biodiesel | 62 | g | (Oleon Gent, may vary from 20 |
| | | | to 200 g) |
| Surfactant | 12 | g | Tegostab ™ B 8870 |
| Catalyst | 2.1 | g | DMDEE |
| | | | (dimorpholinodiethylether) |
| Emulsifying agent | 9 | g | Altachem ™ FCA400 and FCA500 |
| and rheology modifier | | | |
| MDI | 300 | g | Suprasec ™ 5025 |
| LPG | 116 | g | Propane/butane/isobutane |
| DME | 29 | g | Dymel ™ A |

2-2 KPU rigid foam system (pbw)

| Polyol OHv 350 | 100 | pbw | Voranol ™ |
|---|---|---|---|
| Biodiesel | 20 to 150 pbw | | Oleon Gent |
| Surfactant | 2 | pbw | SR234 |
| Blowing agent (Pentane; F 141b;.) | 20 to 30 pbw | | fréon 141b |
| Tertiary amine | 2 | pbw | catalyst SFC |
| MDI | 75 | pbw | Suprasec ™ 5025 |

In summary, the invention is directed to a process for preparing one component polyurethane foam (OCF) precursor mixtures to be packed in pressurized vessels and or aerosol cans wherein biodiesel is included as latent hardener and extender. The use of biodiesel will prevent the drift of viscosity on aging since it is very efficient as viscosity reducer. Biodiesel allows for the reduction of the content of DME that is some cases can even be eliminated.

Biodiesel is used as extender and diluent in formulations in the range 1 percent to 60 percent, preferably in the range of 5 percent to 30 percent leading to a highly stable OCF foam with very stable properties due to non-migration of the extender. According to an embodiment of the invention, the biodiesel is a mixture of methyl and ethyl fatty acid esters included in the range from 1 to 50%, preferably 5 to 30% by weight of the composition.

The polyurethane precursor is preferably a composition comprising an isocyanate quasi-prepolymer based on MDI and a polyether-polyols and 1 to 50%, preferably 5 to 30 percent by weight, of a mixture of methyl and/or ethyl fatty acid esters.

According to another embodiment of the invention biodiesel may be advantageously used for preparing a precursor of an unsaturated polyester foam, a foam based on cyclocarbonate oligomers and primary amine oligomers, or a foam based on acrylic oligomers.

1. A polymer foam precursor composition comprising 1 to 60%, preferably 5 to 30% by weight, of a biodiesel obtained by transesterification of vegetable oils.

2. A composition according to claim 1 wherein the polymer foam is a polyurethane foam.

3. A composition according to claim 1 wherein the biodiesel is a mixture of methyl fatty acid esters.

4. Composition according to claim 1 wherein the biodieset is a mixture of methyl and ethyl fatty acid esters.

5. A composition according to claim 1 wherein the biodiesel is a mixture of ethyl fatty acid esters.

6. A composition according to claim 1 which is a formulated as a one component polyurethane foam precursor.

7. A composition according to claim 1 which is a formulated as a two component polyurethane foam precursor.

8. A composition according to claim 1 comprising quasi-prepolymer with isocyanate functionality, preferably derived from polyether-polyol and diphenylmethane di-isocyanate.

9. A process for preparing pressurized vessels and or aerosol cans containing precursor mixtures of polymer foam comprising a step wherein biodiesel is included in the mixture as a latent hardener and/or extender and/or liquid filler.

10. Process according to claim 9 wherein the polymer foam is a polyurethane foam.

11. A composition according to claim 2 wherein the biodiese is a mixture of methyl fatty acid esters.

12. Composition according to claim 2 wherein the biodiesel is a mixture of methyl and ethyl fatty acid esters.

13. A composition according to claim 2 wherein the biodiesel is a mixture of ethyl fatty acid esters.

14. A composition according to claim 2 which is a formulated as a one component polyurethane foam precursor.

15. A composition according to claim 2 which is a formulated as a two component polyurethane foam precursor.

16. A composition according to claim 2 comprising quasi-prepolymer with isocyanate functionality, preferably derived from polyether-polyol and diphenylmethane di-isocyanate.
